(19) United States
(12) Patent Application Publication
(10) Pub. No.: US 2010/0133719 A1
(43) Pub. Date: Jun. 3, 2010

(54) Dual color molding apparatus used in measuring tape and molding method thereof

(75) Inventor: Fu-Cheng Sun, Sindian City (TW)

Correspondence Address: ROGER H. CHU, 19499 ERIC DRIVE, SARATOGA, CA, 95070, US

(73) Assignee: TAIWAN SAN TYAU CO., LTD., Sindian City (TW)

(21) Appl. No.: 12/326,098

(22) Filed: Dec. 1, 2008

(51) Int. Cl. B29C 39/12

(52) U.S. Cl. 264/246; 425/112

(57) ABSTRACT

The present invention discloses a dual color molding apparatus for a measuring tape and its molding method, and a dual color plastic technology is used to replace the existing label and decoration such as a label on the measuring tape and provide a different design of words, numbers or logos on a concave and convex surface to facilitate users to identify the molding apparatus. The molding apparatus includes a male mold fixing base, a first male mold, a second male mold, a female mold fixing base, a first female mold, a second female mold, a central axle and a middle plate. The first female mold forms a first cavity with any one of the male molds, and the second female mold forms a second cavity with any one of the male molds, and a glue injection is performed in the first cavity and the second cavity by a first glue injection unit and a second glue injection unit respectively. The first female mold and the second female mold are coupled to the female mold fixing base, and the first male mold is installed above a first male mold insert fixing base of the male mold fixing base, and the second male mold is installed above a second male mold insert fixing base of the male mold fixing base, and both first male mold and second male mold are coupled to the middle plate, and the first male mold is rotatably installed at the top of the second male mold insert fixing base and the second male mold is rotatably installed at the top of the first male mold insert fixing base through the central axle connected to the middle plate. Therefore, a dual color glue injection can be completed for the dual color mold without replacing the molding apparatus.

### BACKGROUND OF THE INVENTION

1. Field of the Invention

The present invention relates to a molding apparatus, and more particularly to a dual color molding apparatus of a dual color mold finished good and its molding method can be achieved without replacing the molding apparatus, and the dual color molding apparatus is applied onto a surface of a manual measuring tape or a general hand tool.

2. Description of the Related Art

As plastic technologies and products advance constantly, plastic injection technologies and products become an important part of the plastic manufacturing technology, and various plastic injection products have been used extensively in our life, office and home. Although the plastic injection technology develops rapidly, consumer requirements keep varying, and thus the plastic injection technology requires further improvements and developments, and related technological industries positively develop effective improved plastic injection technology and innovation.

At present, the principle of molding a product by a general metal die cast mold or a plastic injection mold melts the material (plastic or metal) of a finished good at a high temperature, and applies a pressure in a cavity, and finally removes the finished good from the cavity after a cooling process. The structure of these molds are basically the same, and the manufacture and the volume of the molds depend on the material, shape and size of different finished goods, and the mold industry has established a general standard specification to cope with the selection of material and size. However, the quality of structural design of the molds determines the quality of the molded products and requires specific experience and technology.

In the present plastic injection technologies, a common dual color plastic injection technology comprises the following steps:
1. A first mold injection of a first plastic step;
2. A first mold opening step;
3. A semi-finished good material removal step;
4. A semi-finished good conveying step;
5. A semi-finished good placed into a second mold step;
6. A second mold injection of a second plastic step;
7. A second mold opening step; and
8. A dual color finished good material removal step;

The foregoing eight steps are adopted in the commonest dual color plastic injection technology and the aforementioned prior art still has the following problems:
1. The dual color plastic injection technology injects a first plastic into a first mold to produce a semi-finished good and then transfers the semi-finished good into a second mold, and injects a second plastic in the second mold. This step is carried out manually, and thus is troublesome and time-consuming and also incurs a high operation cost.
2. Since the dual color plastic injection technology requires repeated switches between the two sets of molds, the prior art not only occupies too much space, but also requires a larger operating force for the displacement. The machine in accordance with the prior art is larger, and the two sets of injection molds result in insufficient factory space and high machine cost.

In the present hand tool industry, various brands of different manufacturers and the operating instructions are usually labeled on the surface of a measuring tape. Although such arrangement makes the production simpler and easier, consumers still have difficulties to select a product with their desired features among all these brands. Therefore, it is an important subject for related manufacturers to develop a dual color molding apparatus and a method of manufacturing the molding apparatus used for a measuring tape to appeal consumers.

### SUMMARY OF THE INVENTION

Therefore, it is a primary objective of the present invention to provide a dual color mold molding apparatus capable of completing the manufacture of measuring tape finished goods without the need of replacing the molding apparatus. With the dual color mold feature, a concave and convex effect for displaying a plurality of words, numbers or logos indicating the brand and improving the brand awareness can be achieved

To achieve the foregoing objective, the present invention provides a dual color molding apparatus used in a measuring tape and its molding method, and the molding apparatus comprises a male mold fixing base, a first male mold, a second male mold, a female mold fixing base, a first female mold, a second female mold, a central axle and a middle plate. The first female mold forms a first cavity with any one of the male molds, and the second female mold forms a second cavity with any one of the male molds, and a glue injection is performed in the first cavity and the second cavity by a first glue injection unit and a second glue injection unit respectively. The first female mold and the second female mold are coupled to the female mold fixing base, and the first male mold is installed above a first male mold insert fixing base of the male mold fixing base, and the second male mold is installed above a second male mold insert fixing base of the male mold fixing base, and both first male mold and second male mold are coupled to the middle plate, and the first male mold is rotatably installed at the top of the second male mold insert fixing base and the second male mold is rotatably installed at the top of the first male mold insert fixing base through the central axle connected to the middle plate.

In another preferred embodiment of the present invention, a dual color molding method for a measuring tape comprises the steps of:

closing a first female mold and a first male mold to form a first cavity;

performing a glue injection in the first cavity to produce a mold semi-finished good in the first cavity;

separating the first female mold and the first male mold and placing the mold semi-finished good on the first male mold;

rotating the first male mold to a position corresponding to a second female mold, and closing the second female mold and the first male mold, and forming a second cavity;

performing a glue injection in the second cavity, such that the mold semi-finished good produces a dual color mold finished good in the second cavity; and

separating the second female mold and the first male mold, and removing the dual color mold finished good.

The method of the invention can improve the durability of the measuring tape, and have a better resistance to weather change, and enhance the stability of the measuring tape. With the material of the molding apparatus of the invention, the elasticity of the measuring tape is enhanced, the labor cost is saved, and the yield rate is improved.

The technical contents and characteristics of the present invention are described in details with accompanying drawings as follows.

### BRIEF DESCRIPTION OF THE DRAWINGS

FIG. 1 is a side sectional view of a molding apparatus of the present invention;

FIGS. 2A to 2D are schematic views of a dual color mold of the present invention;

FIGS. 3A and 3B are schematic views of operating a molding apparatus of the present invention; and

FIG. 4 is a flow chart of a molding method of the present invention.

### DETAILED DESCRIPTION OF THE PREFERRED EMBODIMENTS

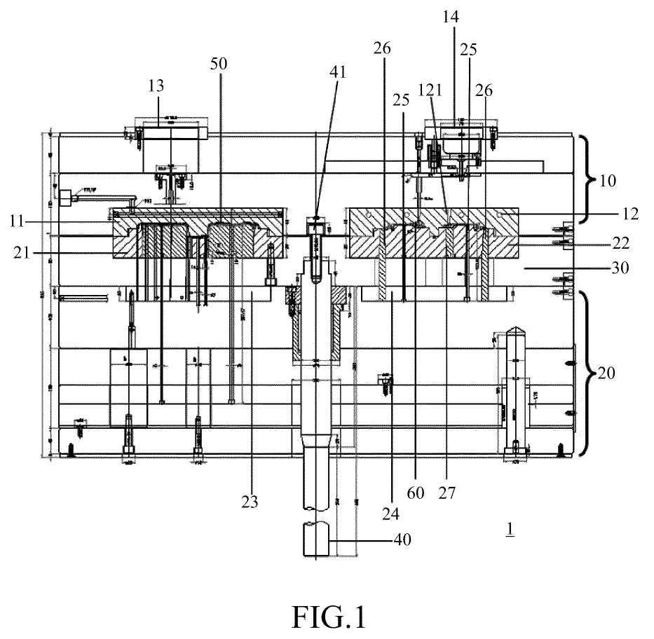

In the dual color molding apparatus of the measuring tape and its molding method in accordance with the present invention, a dual color molding technology is applied to a hand tool product such as a measuring tape and replaces the traditional way of using a label for identifying the brand of the measuring tape by using the dual color mold to create the concave and convex effect and display a plurality of words and numbers to label the brand, increasing the brand awareness and differentiating the product from others in the market. Before describing the method of the present invention, we use an apparatus of the invention for the illustration. With reference to FIG. 1 for a side cross-sectional view of a molding apparatus in accordance with the present invention, the molding apparatus 1 comprises a male mold fixing base 20, a first male mold 21, a second male mold 21, a female mold fixing base 10, a first female mold 11, a second female mold 12, a central axle 40 and a middle plate 30. A first cavity 50 is formed between the first female mold 11 and the first male mold 21 in a mold closing process or between the first female mold 11 and the second male mold 22 in a mold closing process. A second cavity 60 is formed between the second female mold 12 and the second male mold 22 in a mold closing process, or between the second female mold 12 and the first male mold 21 in a mold closing process. Therefore, the position of the first cavity 50 is situated below the first female mold 11, and the position of the second cavity 60 is situated below the second female mold 12, regardless of which male mold is closed. A glue is injected into the first cavity 50 and the second cavity 60 by a first glue injection unit 13 and a second glue injection unit 14 respectively, and a plurality of glue injection passages 111 disposed on the first female mold 11 and a plurality of glue injection passages 121 disposed on the second female mold 12 are used for the glue injection. The first female mold 11 and the second female mold 12 are connected to the female mold fixing base 10 and fixed onto the female mold fixing base 10. The first male mold 21 is installed at the top of a first male mold insert fixing base 23 of the male mold fixing base 20, and the second male mold 22 is installed at the top of a second male mold insert fixing base 24 of the male mold fixing base 20, and the first male mold 21 and the second male mold 22 are connected to the middle plate 30, and the first male mold 21 is rotatably installed at the top of the second male mold insert fixing base 24 through the central axle 40 connected to the middle plate 30, and the second male mold 22 is rotatably installed at the top of the first male mold insert fixing base 23.

The second male mold insert fixing base 24 further installs a plurality of knock-out pins 25 for propping and removing the material and carrying out a next plastic injection molding when the dual color mold is completed in the second cavity 60. The second male mold insert fixing base 24 further installs a plurality of positioning rods 26 passed into the first or second male mold 21, 22 to assist positioning the second male mold insert fixing base 24 after the rotation.

In addition, the central axle includes an axle 41 installed at the top of the central axle, and the axle 41 is connected to the middle plate 30 for driving the middle plate 30 to move upward and perform a rotation after the second male mold 22 is separated from the positions of the knock-out pins 25 and the positioning rods 26. After the positions of the first male mold 21 and the second male mold 22 are switched and moved downward, the knock-out pins 25 and the positioning rods 26 are passed into the first male mold 21.

Further, a male mold insert 27 is installed separately in the first male mold 21 and the second male mold, such that a color plastic material is injected at the male mold insert 27.

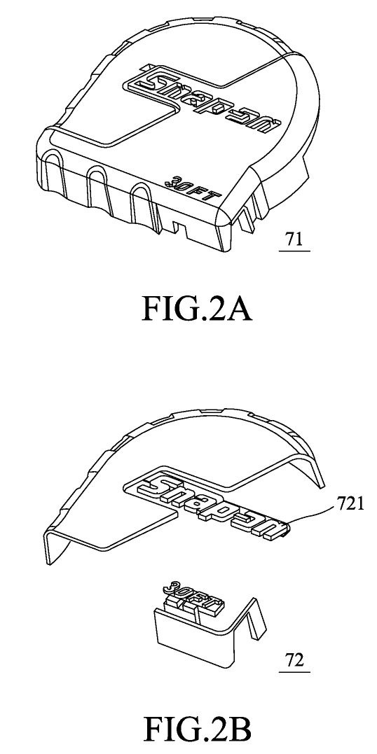

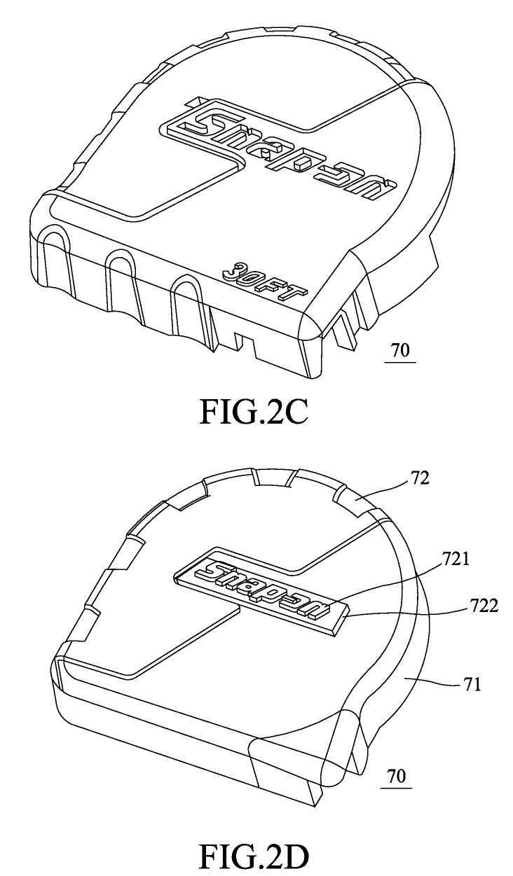

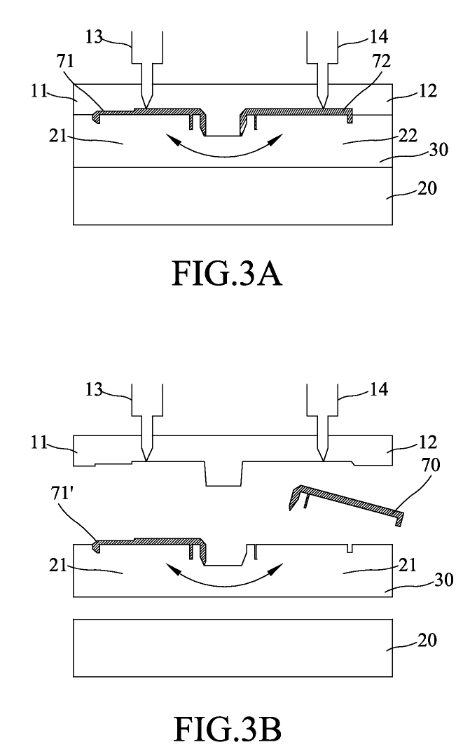

With reference to FIGS. 2A to 2C for schematic views of a dual color mold in accordance with the present invention, and FIGS. 3A and 3B for schematic views of movements of a molding apparatus in accordance with the present invention, if a dual color mold 70 is formed as shown in FIG. 2C, it is necessary to close a first female mold 11, and perform a glue injection in a second female mold 12, a first male mold 21, and a second male mold 22 by the first glue injection unit 13 to form a first mold 71 of a first color, and after the middle plate 30 is rotated to drive the first male mold 21 and the second male mold 22 to separate the male mold fixing base 20, their positions are switched, so that the first mold 71 is disposed below the second female mold 12, and then the molds are closed again, and the first glue injection unit 13 and the second glue injection unit 14 perform the glue injection simultaneously. Now, the second glue injection unit 14 will inject a second mold 72 with a second color onto the first mold 71 to produce a dual color mold 70. In the meantime, the first glue injection unit 13 will perform a glue injection to form a first mold 71′ of a first color. The aforementioned procedure is repeated continuously, and the middle plate 30 is rotated to form the dual color mold 70 without replacing the molding apparatus.

The first mold 71 is made of a hard plastic material such as a mixed plastic of poly carbonate (PC) and acrylonitrile butadiene styrene (ABS), and the material hardness (HARDNESS SHORE A) falls within a range from 100 to 130, and the second mold 71 is made of a soft plastic material which has an excellent mechanical property, heat resistance, weather resistance, UV stability, elasticity, comfortability and dry misty surface, and connected to PC, ABS, PC/ABS, and the material hardness (HARDNESS SHORE A) of the material such as (thermal plastic rubber) TPR or thermal plastic rubber (TPU) falls within a range from 30 to 90.

If it is necessary to manufacture a dual color mold 70 having a plurality of words or numbers as shown in FIG. 2D, the words or numbers 721 are not connected together with each other, and thus it is necessary to install a plurality of glue injection passages 111, 121 on the first female mold 11 and the second female mold 12, and the number of molds 11, 12 and the corresponding glue injection passages 111, 121 are determined according to the plurality of words or numbers. In other words, the design cost for the female mold is increased greatly, and the glue injection positions of the first glue injection unit 13 and the second glue injection unit 14 have to be changed frequently, and thus such arrangement is very inconvenient. Taking the requirements of the appearance of the dual color mold 70 into consideration, we can inject a glue at a position of a glue connecting position 722 under the word or number 721 for performing a glue injection at the male mold insert 27, so that after the glue injection at the glue connecting position 722 is completed, the level of glue along the areas of each word or number 721 rises, and the finished good of a dual color mold 70 having a word, a number or a logo is produced, and such arrangement reduces the number of glue injection passages 111, 121 greatly.

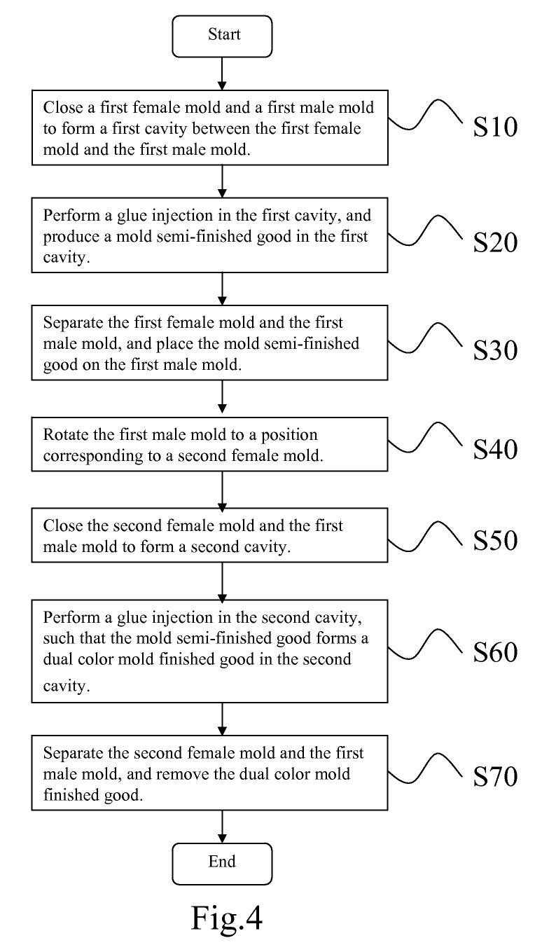

With reference to FIG. 4 for a flow chart of a preferred embodiment of the present invention, the dual color molding method comprises the steps of: closing a first female mold and a first male mold, and forming a first cavity between the first female and male molds (Step S10); performing a glue injection in the first cavity such that a mold semi-finished good is produced in the first cavity (Step S20), wherein the mold semi-finished good as shown in FIG. 2A has a first mold 71 of a first color; separating the first female mold and the first male mold, and situating the mold semi-finished good on the first male mold (Step S30); rotating the first male mold to a position of a corresponding second female mold (Step S40); closing a second female mold and a first male mold to form a second cavity between the second female mold and the first male mold (Step S50); performing a glue injection in the second cavity, such that the mold semi-finished good forms a dual color mold finished good in the second cavity (Step S60), wherein the dual color mold finished good is a dual color mold 70 having two colors as shown in FIG. 2C; and separating the second female mold and the first male mold and removing the dual color mold finished good (Step S70) to complete producing the dual color mold.

Since the positions of the first male mold and the second male mold are rotated and switched, it is necessary to align and confirm their positions corresponding to the first female mold and the second female mold respectively. Before Step S40, it is necessary to release the positioning of the first male mold and the second male mold, and use a middle plate to drive the first male mold and the second male mold to rotate. After Step 40, the positions of the first and second male molds are rotated and switched, the first and second male molds are positioned to facilitate carrying out Step 50.

While a glue injection is being performed in the second cavity, a glue injection is performed in the first cavity to form a first mold of a first color, and the foregoing procedure is repeated continuously, and the middle plate is rotated to form a dual color mold without replacing the molding apparatus, and such application is very practical.

A knock-out pin is provided for removing the dual color mold finished good, and the dual color mold is pushed and separated from the first male mold or the second male mold, so that the dual color mold will drop into a collection box automatically or at a place convenient for users to collect. After Step 70, the first male mold is rotated to a position corresponding to the first female mold, and a glue injection is performed for the next mold.

The first mold is made of a hard plastic material such as a mixed plastic of poly carbonate (PC) and acrylonitrile butadiene styrene (ABS), and the material hardness (HARDNESS SHORE A) falls within a range from 100 to 130, and the second mold is made of a soft plastic material such as a thermal plastic rubber (TPR) or a thermal plastic polyurethane (TPU) having the mechanical advantages of heat resistance, weather resistance, UV stability, elasticity, comfortability and dry misty surface, and can be coupled with PC, ABS or PC/ABS, and the material hardness (HARDNESS SHORE A) falls within a range from 30 to 90.

If it is necessary to produce a dual color mold having a plurality of words or numbers as shown in FIG. 2D, the first female mold and the second female mold must have a concave and convex surface corresponding to such words, numbers or logos to facilitate the glue injection of the words, numbers or logos in the second cavity. The glue injection can be carried out under the concave and convex surface to form a glue connecting position for each word or number, and then the glue injection is continued, and the glue along the areas of each word or number rises until the areas are filled up with glues, so as to complete a dual color mold finished good having words, numbers or logos. Since the present invention applies the traditional dual color plastic injection technology to the hand tool industry particularly the measuring tape industry, the present invention greatly reduces the production time and the production cost of the dual color plastic injection, and also improves the brand awareness of the measuring tape and the consumer's willingness of buying the measuring tape.

In summation of the description above, the present invention improves over the prior art and complies with the patent application requirements, and thus is duly filed for patent application. While the invention has been described by means of specific embodiments, numerous modifications and variations such as a molding apparatus of three or more colors could be made by those skilled in the art without departing from the scope and spirit of the invention set forth in the claims.

What is claimed is:

1. A dual color molding apparatus used in a measuring tape, comprising:
a male mold fixing base, having a first male mold insert fixing base and a second male mold insert fixing base;
a first male mold, installed at the top of the first male mold insert fixing base;
a second male mold, installed at the top of the second male mold insert fixing base; and
a female mold fixing base, coupled to a first female mold and a second female mold;
wherein a first cavity is formed between the first female mold and any one of the male molds, and a second cavity is formed between the second female mold and any one of the male molds, and the first cavity and the second cavity perform a glue injection through a first glue injection unit and a second glue injection unit respectively; and
the first male mold and the second male mold are connected to a middle plate, and a central axle connected to the middle plate is provided for rotatably installing the first male mold at the top of the second male mold insert fixing base and rotatably installing the second male mold at the top of the first male mold insert fixing base.

2. The dual color molding apparatus used in a measuring tape of claim 1, wherein the second male mold insert fixing base has a plurality of knock-out pins installed thereon.

3. The dual color molding apparatus used in a measuring tape of claim 1, wherein the second male mold insert fixing base further includes a plurality of positioning rods installed thereon and passed into the first or second male mold to assist rotating the second male mold inset fixing base after its positioning.

4. The dual color molding apparatus used in a measuring tape of claim 1, wherein the central axle includes an axle installed at the top of the central axle and connected to the middle plate, for driving the middle plate to move upward to the second male mold and perform a rotation after separating each positioning rod, and then move downward after the positions of the first male mold and the second male mold are switched, such that the positioning rod can be passed into the first male mold correspondingly.

5. The dual color molding apparatus used in a measuring tape of claim 1, wherein the first mold is made of a hard plastic material, and the material hardness (HARDNESS SHORE A) falls within a range from 100 to 130.

6. The dual color molding apparatus used in a measuring tape of claim 5, wherein the hard plastic material is a mixed plastic of poly carbonate (PC) and acrylonitrile butadiene styrene (ABS).

7. The dual color molding apparatus used in a measuring tape of claim 1, wherein the second mold is made of a soft plastic material having a material hardness (HARDNESS SHORE A) falling within a range from 30 to 90.

8. The dual color molding apparatus used in a measuring tape of claim 7, wherein the soft plastic material is thermal plastic rubber (TPR) or thermal plastic polyurethane (TPU).

9. The dual color molding apparatus used in a measuring tape of claim 1, wherein the first female mold and the second female mold include a plurality of glue injection passages disposed thereon, and a male mold insert is installed separately into the first male mold and the second male mold for injecting a color plastic material at the position of the male mold insert.

10. The dual color molding apparatus used in a measuring tape of claim 9, wherein a glue is injected at a position of the male mold insert to define a glue connecting position, so as to reduce the number of the glue injection passages.

11. A dual color molding method for a measuring tape, comprising the steps of:
closing a first female mold and a first male to form a first cavity between the first female mold and the first male mold;
performing a glue injection in the first cavity to produce a mold semi-finished good in the first cavity;
separating the first female mold and the first male mold, and situating the mold semi-finished good on the first male mold;
rotating the first male mold to a position corresponding to a second female mold, and closing a second female mold and a first male forming a second cavity between the second female mold and the first male;
performing a glue injection in the second cavity, and allowing the mold semi-finished good to form a dual color mold finished good in the second cavity; and
separating the second female mold and the first male mold, and removing the dual color mold finished good.

12. The dual color molding method for a measuring tape of claim 11, further comprising the steps of: releasing the positioning of the first male mold and the second male mold, using a middle plate to drive the first male mold and the second male mold to rotate, and positioning the first male mold and the second male mold after the positions are rotated and switched.

13. The dual color molding method for a measuring tape of claim 11, wherein a glue injection is performed in the first cavity, while a glue injection is being performed in the second cavity.

14. The dual color molding method for a measuring tape of claim 11, wherein the dual color mold finished good is removed by a knock-out pin, and the knock-out pin automatically pushes the dual color mold to separate the first male mold.

15. The dual color molding method for a measuring tape of claim 11, further comprising a step of rotating the first male mold to a position corresponding to the first female mold after the dual color mold finished good is removed.

16. The dual color molding method for a measuring tape of claim 11, wherein the first mold is made of a hard plastic material having a material hardness (HARDNESS SHORE A) falling within a range from 100 to 130.

17. The dual color molding method for a measuring tape of claim 16, wherein the hard plastic material is a mixed plastic of poly carbonate (PC) and acrylonitrile butadiene styrene (ABS).

18. The dual color molding method for a measuring tape of claim 11, wherein the second mold is made of a soft plastic material having a material hardness (HARDNESS SHORE A) falling within a range from 30 to 90.

19. The dual color molding method for a measuring tape of claim 18, wherein the soft plastic material is a thermal plastic rubber (TPR) or a thermal plastic polyurethane (TPU).

20. The dual color molding method for a measuring tape of claim 11, further comprising a step of performing a glue injection under the concave and convex surfaces on the first female mold and the second female mold corresponding to the words, numbers or logos to form a glue connecting position at the bottom of each word, number or logo, and continuing the glue injection, if it is necessary to form a dual color mold having a plurality of words, numbers or logos.
